(19) United States
(12) Patent Application Publication
(10) Pub. No.: US 2007/0157168 A1
(43) Pub. Date: Jul. 5, 2007

(54) Unified date and time model

(76) Inventors: Tobias Traxel, Walldorf (DE); Markus Eble, Waldorf (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/321,487

(22) Filed: Dec. 29, 2005

(51) Int. Cl. G06F 9/44

(52) U.S. Cl. 717/120

(57) ABSTRACT

In an embodiment, a software system is configured with multiple time axes to represent one or more time elements. The system is also configured to allow a user of the system to select one or more of the multiple time axes with which that user would like to work.

### BACKGROUND

The aphorism “since the beginning of time” has been around since the beginning of time. Sometime after the beginning of time, man created a system for the keeping of time, and that system, while experiencing some adjustments throughout history commensurate with the understanding of the universe, has pretty much been in place since then. For much of history, the time that was important to people was the time of their locality, since travel throughout the world was slow, limited, or non-existent. However, with the increasing ability to travel and communicate across time zones, and increasingly complex business relationships, times other than the local time became important to more and more people. The use of times in addition to local times has become particularly important with the advent of computers and computer networks, as a multi-national company that uses a computer system has to determine the proper time to use in that system.

For example, in current computer systems, if a date and time is needed for a particular purpose, such as to associate with the date and time that a file is created, or in a business application to timestamp a sales receipt at a fast food restaurant, the date and time is normally determined from a UTC time axis. To this UTC time axis, which begins at a certain date (e.g., Jan. 1, 1970), is added the number of micro-seconds, as determined by the internal clock of a processing unit, that have elapsed since that certain date. This produces a number, which the system can then convert into a date and time for use by the computer system.

However, this timestamp represents only a local time, and if a computer system is accessed by people or entities across several time zones, the timestamp of the central processing unit will generate a timestamp for a single time zone (more likely than not the time zone in which the processing unit is located). However, if this central system is being accessed by a store in a different time zone, any receipts, invoices, bills of laden, or other business documents which are timestamped will not have the local time of that system. The art is therefore in need of a more diverse time system for computer systems.

### SUMMARY

In an embodiment, a software system is configured with multiple time axes to represent one or more time elements. The system is also configured to allow a user of the system to select one or more of the multiple time axes with which that user would like to work.

### BRIEF DESCRIPTION OF THE DRAWINGS

FIG. 1 illustrates an example embodiment of a process to configure a computer system with multiple time axes.

FIG. 2 illustrates an example embodiment of a system architecture upon which an embodiment of the invention may execute.

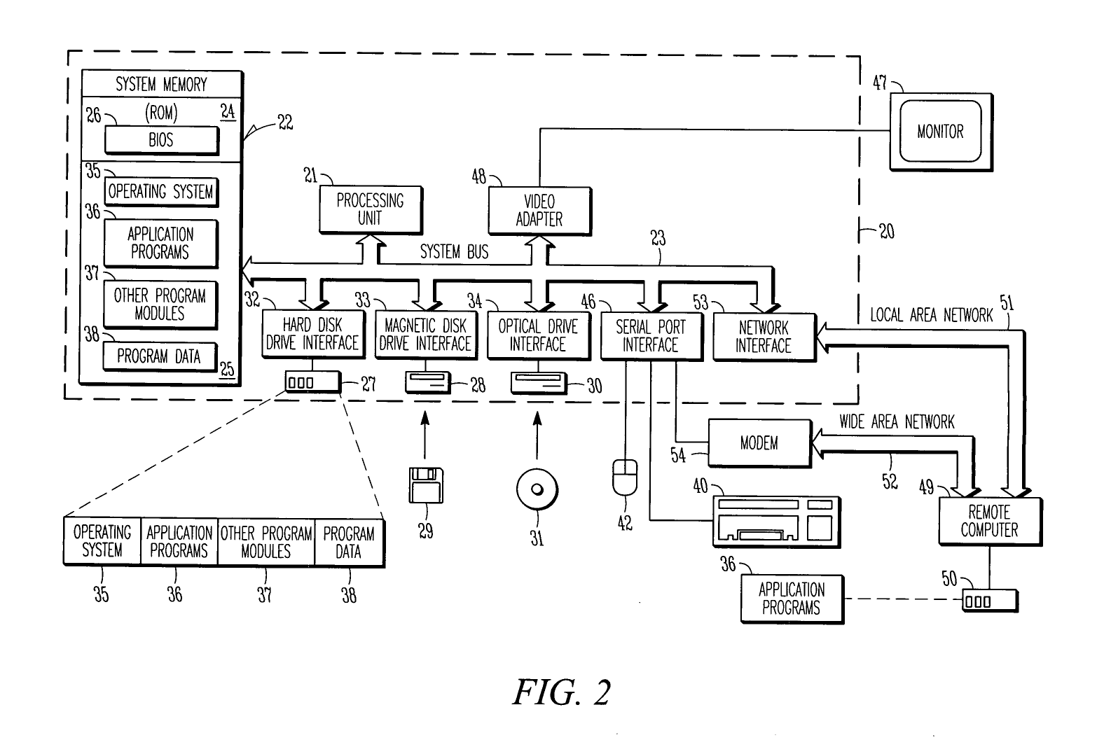

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Embodiments of the invention address the issue of global time keeping, i.e., timekeeping across multiple time zones, via a complete set of types for time points, and may be referred to as a Unified Date and Time Model. These types may be used to cover all variants of the time points that occur in business processes. Embodiments define the time point types, operational semantics for these types, and rules for conversion between the types.

The basic types for time points in an embodiment of the invention include Time, Date, Global Date-Time, Local Offset Date-Time, Local Date-Time, Time Zone Independent Date-Time, and a Time Point.

The Time Point is a dimensionless point on a time axis. The time axis upon which a Time Point may appear may be any one of the above-listed Time, Date, Global Date-Time, Local Offset Date-Time, Local Date-Time, and Time Zone Independent Date-Time time axes. In an embodiment, the time axis to use in a particular application is defined by the user of the application. While the Time Point allows the use of multiple time axis with different origins, the UTC time is used as a reference.

In an embodiment, the Time type is the time of day in a twenty-four hour day. The Date is the day on a Gregorian calendar. The Date is the same date all over the globe, and it doesn't change when moving from one time zone to another. The Global Date-Time is the date and time in UTC format. The Local Offset Date-Time is the local date and time plus the offset from the UTC timestamp. The Local Date-Time is the “real” local date and time. That is, it is the local date and time including time zone information and a daylight savings time indicator. The daylight savings time indicator is used to identify whether standard time or daylight savings time is in effect, and further is used to differentiate the duplicate hour when changing from daylight savings time to standard time. The Time Zone Independent Date-Time is a date and time point that is independent of any time zone information.

In an embodiment, at least four different use cases are defined for Time Points. There is a first case in which only the date is of interest. Examples include a person's birthday and New Years Day (always January 1). There is no time associated with this Date Time Point, and the date remains unchanged from one time zone to another.

In a second case, the time of day is important without reference to any particular time zone. This second case is useful, for example, in noting the opening time of a chain of fast food restaurants across multiple time zones. That is, all of these restaurants may open at 6:00 local time, irrespective of the time zone in which the restaurant is located.

In a third case, an exact Time Point is important throughout all time zones. For example, the participants in a telephone conference call must all meet at the same time, irrespective of the time zone in which each participant resides. Therefore, to ensure that all participants meet at the same time, the meeting is scheduled via the Global Date-Time in UTC format, and any application converts the UTC Time Point into each participant's local time zone (i.e, the Local Offset Date-Time).

In a fourth case, some applications, while working with global Time Points, must store the information exactly as entered. This may be the case for example in noting the date and time that a legal contract begins and/or terminates. Indeed, in some instances, for legal reasons, a conversion to the UTC or other time axis is not allowed in the persistence of the date and time throughout the system. In such cases, the application should work with the date, time, and time zone internally. In another embodiment, a later conversion of the date and time may be permitted.

In an embodiment, an application utilizing a unified date and time model will handle many functions involving the multiple time axes such as the conversions between different units. The model also may determine the time interval including a given time point, and it may calculate the rounding of time points relative to the model, such as determining a time interval and returning a start or end time point. The model may furthermore handle the numbering of occurrences such as the week number of the year (1-52), or the day of the year (1-365). The model may further handle adding and/or subtracting durations, and calculating the duration between two time points.

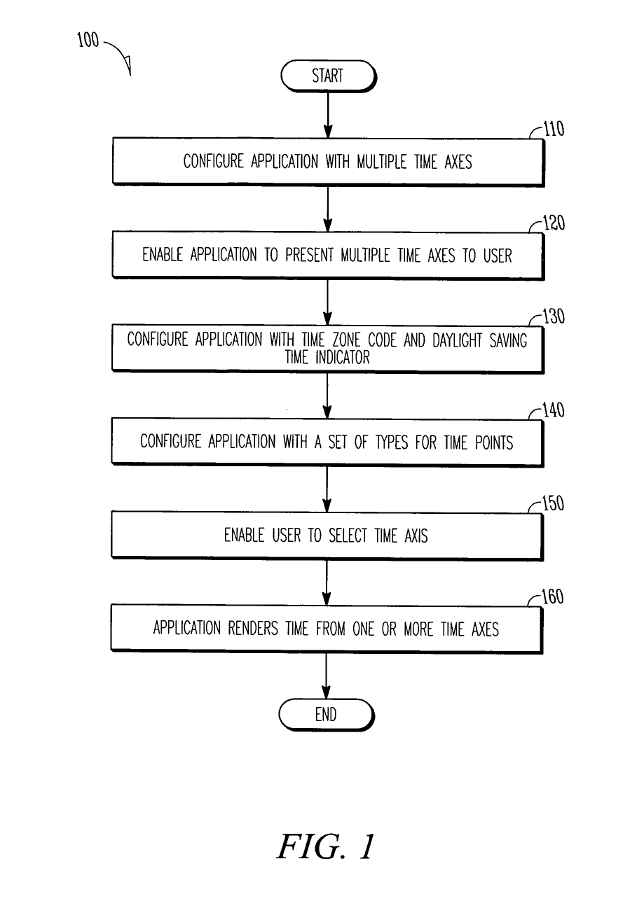

FIG. 1 illustrates an embodiment of a process 100 in which a computer system is configured to function with multiple time axis. In operation 110, a software application is configured with multiple time axes to represent one or more time elements and to present to a user a selection of one or more of the multiple time axes at operation 120. At operation 130, the software application is configured with a time zone code and a daylight savings time indicator. This imbues the application with the ability to differentiate a duplicate hour in transitioning between daylight savings time and standard time. This duplicate hour is normally 2:00 AM on the Sunday morning that the time is changed from daylight savings time to standard time.

Operation 140 configures a software application with a set of types for time points to cover all variants in time points that may occur in a business process. As previously disclosed, these types include a time point on a Time (twenty four hour day time) axis, a Date (Gregorian date) axis, a Global Date-Time (UTC time) axis, a Local Offset Date-Time (local date and time axis offset from the UTC time) axis, a Local Date-Time (local date and time axis including time zone data and a daylight savings time indicator) axis, and a Time Zone Independent Date-Time (date and time axis independent of a time zone) axis.

FIG. 1 further illustrates at operation 150 that the software application may be configured so as to enable a user at the run time of the application to select one of the multiple time axes for the application. Then at run time, at operation 160, the application can render a time from one or more of the multiple time axes.

FIG. 5 is an overview diagram of a hardware and operating environment in conjunction with which embodiments of the invention may be practiced. The description of FIG. 5 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 5, a hardware and operating environment is provided that is applicable to any of the servers and/or remote clients shown in the other Figures.

As shown in FIG. 5, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 5 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
configuring a software application with multiple time axes to represent one or more time elements; and further
configuring the software application to present a user with a selection of one or more of the multiple time axes.

2. The method of claim 1, further comprising configuring the software application with a time zone code and a daylight savings time indicator, thereby providing the software application with an ability to differentiate a duplicate hour in transitioning between daylight savings time and standard time.

3. The method of claim 1, wherein
the one or more time axes include a time portion and a date portion; and
the multiple time axes comprise one or more of a twenty four hour day time axis, a Gregorian date axis, a UTC time axis, a local date and time axis offset from the UTC time axis, a local date and time axis including time zone data and a daylight savings time indicator, and a date and time axis independent of a time zone.

4. The method of claim 3, wherein one or more of the multiple time axes further comprises a timepoint to indicate a dimensionless point in time.

5. The method of claim 1, wherein the configuration of the software application permits an exchange of time information via a specification of the one or more multiple time axes.

6. The method of claim 1, further comprising:
configuring the software application so as to enable a user at run time of the application to select the time axis for the user's application.

7. The method of claim 1, wherein the configuration of the software application permits a rendering of a time for the application from one or more of the multiple time axes.

8. A system comprising:
a module to configure a software application with multiple time axes to represent one or more time elements; and further
a module to configure the software application to present a user with a selection of one or more of the multiple time axes.

9. The system of claim 8, further comprising a module to configure the software application with a time zone code and a daylight savings time indicator, thereby providing the software application with an ability to differentiate a duplicate hour in transitioning between daylight savings time and standard time.

10. The system of claim 8, wherein
the one or more time axes include a time portion and a date portion; and
the multiple time axes comprise one or more of a twenty four hour day time axis, a Gregorian date axis, a UTC time axis, a local date and time axis offset from the UTC time axis, a local date and time axis including time zone data and a daylight savings time indicator, and a date and time axis independent of a time zone.

11. The system of claim 10, wherein one or more of the multiple time axes further comprises a timepoint to indicate a dimensionless point in time.

12. The system of claim 8, wherein the configuration of the software application permits an exchange of time information via a specification of the one or more multiple time axes.

13. The system of claim 8, further comprising:
a module to configure the software application so as to enable a user at run time of the application to select the time axis for the user's application.

14. The system of claim 8, wherein the configuration of the software application permits a rendering of a time for the application from one or more of the multiple time axes.

15. A machine-readable medium having instructions for executing a process comprising:
configuring a software application with multiple time axes to represent one or more time elements; and further
configuring the software application to present a user with a selection of one or more of the multiple time axes.

16. The machine-readable medium of claim 15, further comprising instructions for configuring the software application with a time zone code and a daylight savings time indicator, thereby providing the software application with an ability to differentiate a duplicate hour in transitioning between daylight savings time and standard time.

17. The machine-readable medium of claim 15, wherein
the one or more time axes include a time portion and a date portion; and
the multiple time axes comprise one or more of a twenty four hour day time axis, a Gregorian date axis, a UTC time axis, a local date and time axis offset from the UTC time axis, a local date and time axis including time zone data and a daylight savings time indicator, and a date and time axis independent of a time zone.

18. The machine-readable medium of claim 17, wherein one or more of the multiple time axes further comprises a timepoint to indicate a dimensionless point in time.

19. The machine-readable medium of claim 15, wherein the configuration of the software application permits an exchange of time information via a specification of the one or more multiple time axes; and further
wherein the configuration of the software application permits a rendering of a time for the application from one or more of the multiple time axes.

20. The machine-readable medium of claim 15, further comprising instructions for:
configuring the software application so as to enable a user at run time of the application to select the time axis for the user's application.
